(19) United States
(12) Patent Application Publication
(10) Pub. No.: US 2007/0160791 A1
(43) Pub. Date: Jul. 12, 2007

(54) Open container for raw food, method of making same

(76) Inventor: Hsin-Hung Chou, Taiepi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,471

(22) Filed: Jan. 6, 2006

(51) Int. Cl. B65D 39/00; B32B 3/10

(52) U.S. Cl. 428/36.5; 428/138; 428/304.4

(57) ABSTRACT

An open container for raw fish and meat is disclosed to have an inner layer, which is formed of a close-cell foam sheet material having a plurality of through holes through top and bottom sides thereof, an outer layer, which is formed of a close-cell foam sheet material, and an intermediate absorptive layer, which is formed of an open-cell foam sheet material having a cell-opening over 80% and bonded between the inner layer and the outer layer.

### BACKGROUND OF THE INVENTION

a. Field of the invention

The present invention relates to an open container for raw fish and meat and more particularly, to a blood water absorptive type open container that has an absorptive intermediate layer for absorbing blood water from storage raw fish and/or meat.

b. Description of the Related Art

In a supermarket, distributor center, or big sales center, polyfoam boxes and dishes are commonly used and covered with a polymer film to hold raw fishes and meat for display. However, dirty water or blood water that flows out of raw fish or meat is kept accumulated in the open container. The accumulated blood water will cause the contained raw fish or meat to decay quickly. Further, displaying raw fish or meat in an open container that is sealed with polymer film and has blood water accumulated therein gives a bad imagine to consumers.

FIGS. 1 and 2 show a conventional open container for raw food 10, which has an absorptive pad 12 placed on the flat bottom 11 to hold raw fish or meat. The absorptive pad 12 absorbs blood water or wastewater from storage raw fish or meat. However, if storage raw fish or meat keeps flowing waste water or blood water after the absorptive pad 12 has absorbed blood water or waste water to the saturated status, overflow blood water or waste water will be accumulated in the open container 10 and mixed with storage raw fish or meat.

Regular open containers for holding raw fish or meat are commonly made out of a closed cell type polyfoam sheet material 21 that is extruded from polymers through an extrusion machine 20. A closed cell type polyfoam sheet material for this purpose has cell size within 0.2˜1.0 mm, thereby providing excellent insulative and leakage preventive characteristics. However, this sheet material is not absorptive due to low cell-opening (about 20%).

### SUMMARY OF THE INVENTION

The present invention has been accomplished under the circumstances in view. It is the main object of the present invention to provide an open container for raw fish and meat, which is comprised of two close-cell foam sheet materials and an open-cell foam sheet material bonded between the close-cell foam sheet materials. The foam sheet materials are respectively molded from polystyrene or polyester. The close-cell foam sheet material that is disposed on the inside of the open container has a plurality of through holes for the passing of blood water from storage fish or meat for absorption by the open-cell foam sheet material. The open container is made by: using extruding machines to extrude polystyrene or polyester compounds into a first close-cell foam sheet material having a cell-opening below 20%, a second close-cell foam sheet material having a cell-opening below 20%, and an open-cell foam sheet material having a cell-opening over 80%, and then laminating the first close-cell foam sheet material, the second close-cell foam sheet material and the open-cell foam sheet material into a compound sheet material in which the open-cell foam sheet material is bonded between the first close-cell foam sheet material and the second close-cell foam sheet material, and then thermoforming the compound sheet material to form a plurality of open containers in the compound sheet material, and then making through holes through top and bottom sides of the first close-cell foam sheet material; and then cutting each open container from the compound sheet material.

### BRIEF DESCRIPTION OF THE DRAWINGS

FIG. 1 is a perspective view of an open container for raw food according to the prior art.

FIG. 2 is a sectional side view of FIG. 1.

FIG. 3 is a schematic elevational view of a conventional extruding machine.

FIG. 4 is an open container manufacturing flow chart according to the present invention.

FIG. 5 is a schematic drawing showing the compound sheet material laminating process according to the present invention.

FIG. 6 is a schematic drawing showing thermoforming of the compound sheet material according to the present invention.

FIG. 7 is schematic drawing showing the structure of thermoforming press according to the present invention.

FIG. 8 is an elevational view of an open container made according to the present invention.

FIG. 9 is a sectional view taken along line 8-8 of FIG. 8.

FIG. 10 is an enlarged view of a part of FIG. 9.

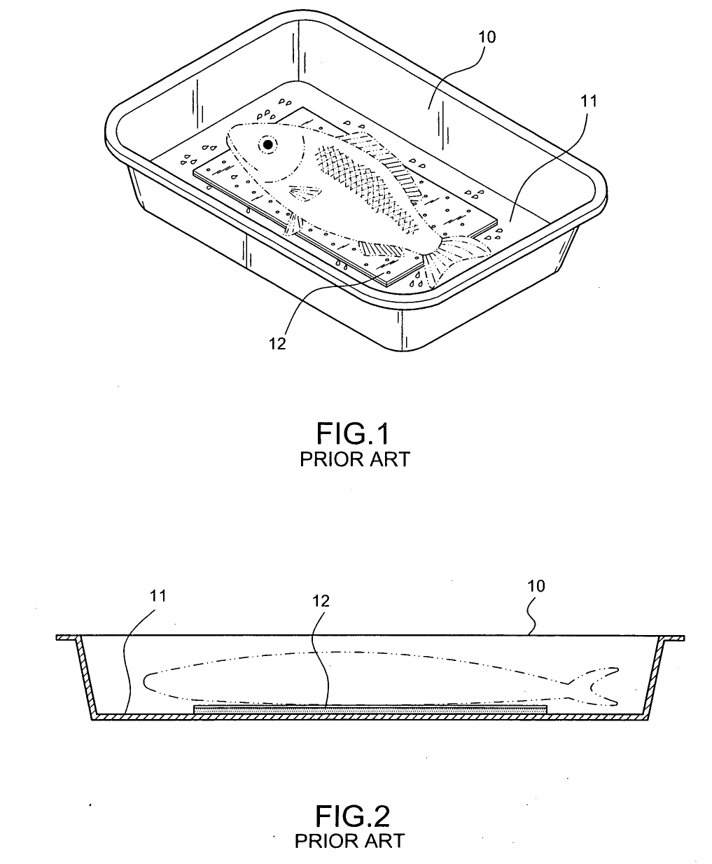

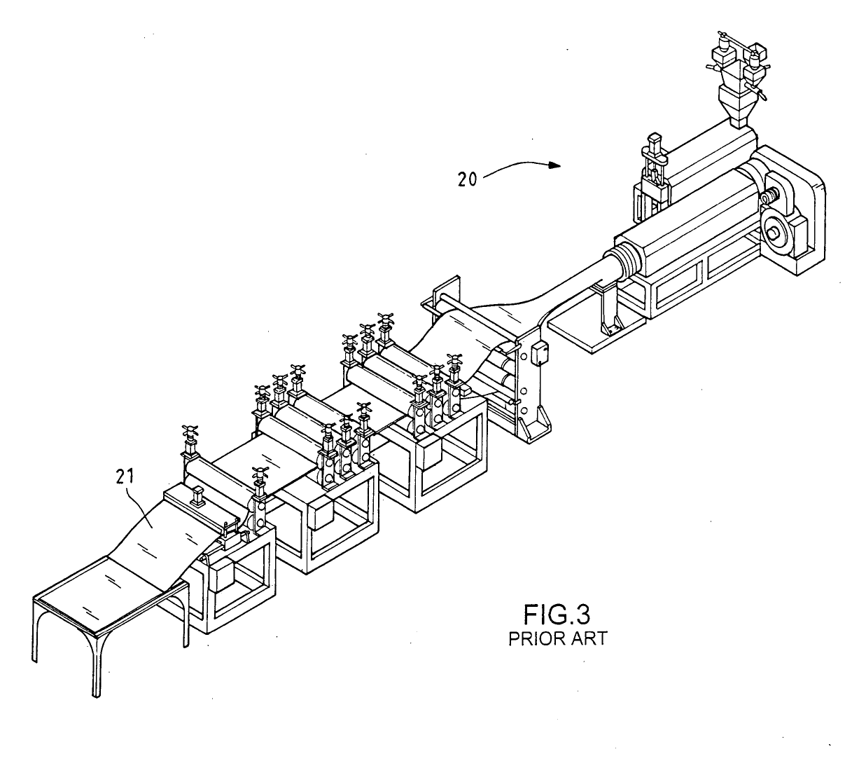

### DETAILED DESCRIPTION OF THE PREFERRED EMBODIMENTS

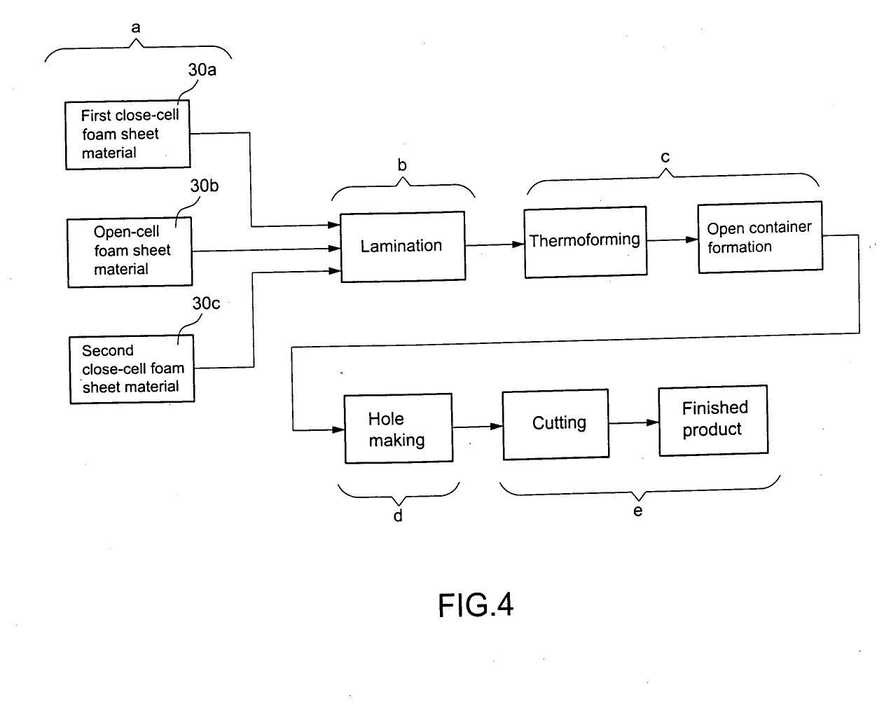

Referring to FIG. 4, an open container manufacturing method in accordance with the present invention comprising the steps of a) material extrusion, b) laminating, c) thermoforming, d) perforating, and e) cutting.

The step of a) material extrusion is to use at least two, or preferably three extruding machines to extrude polymer compounds, into a first close-cell foam sheet material 30a, a second close-cell foam sheet material 30c, and an open-cell foam sheet material 30b. A polymer compound is a mixture of polyester or polystyrene (most preferably, polystyrene) with additives and a foaming agent. Subject to the types of additives used, the flowing characteristic can be changed. A low viscosity helps defoaming, however restraint of foam cell and explosion of cell body may simultaneously occur. Further, additives determine uniformity of foam cell and cell size and help deforming. Therefore, different polyester or polystyrene based compounds containing different additives are used and respectively extruded into the desired first close-cell foam sheet material 30a, second close-cell foam sheet material 30c and open-cell foam sheet material 30b through different extruding machines. Preferably, the cell-opening of the open-cell foam sheet material 30b is over 80%, and the cell-opening of the first close-cell foam sheet material 30a and second close-cell foam sheet material 30c is below 20%.

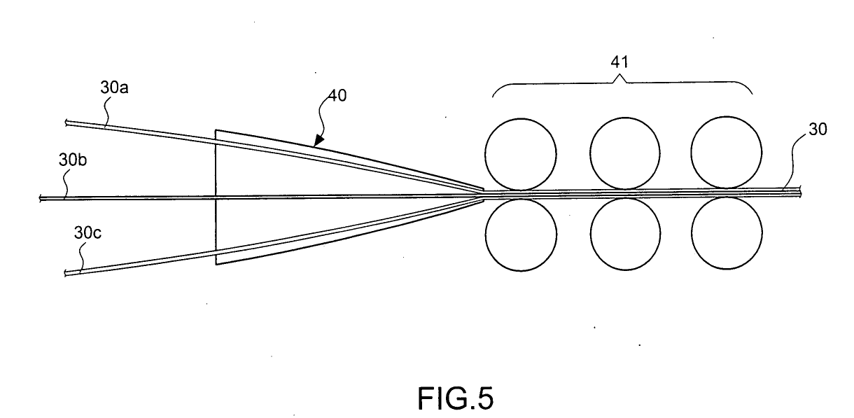

The step of b) laminating is to deliver the first close-cell foam sheet material 30a, the open-cell foam sheet material 30b and the second close-cell foam sheet material 30c thus obtained through a polymerization mold 40 and then a roller-ramming mechanism 41 (see FIG. 5) for enabling the open-cell foam sheet material 30b to be bonded between the first close-cell foam sheet material 30a and the second close-cell foam sheet material 30c to form a compound sheet material 30 of thickness about 3˜6 mm.

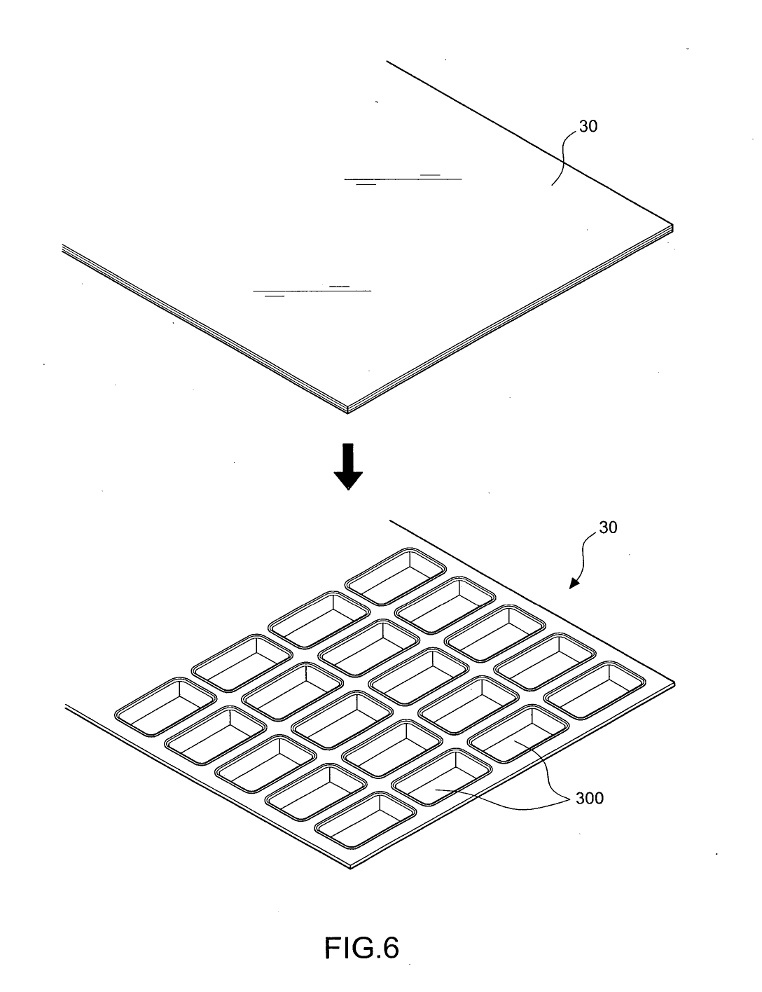

The step of c) thermoforming is to use a thermoforming press to process the compound sheet material 30 thus obtained, thereby forming a plurality of open containers 300 transversely longitudinally aligned in the compound sheet material 30 (see FIG. 6).

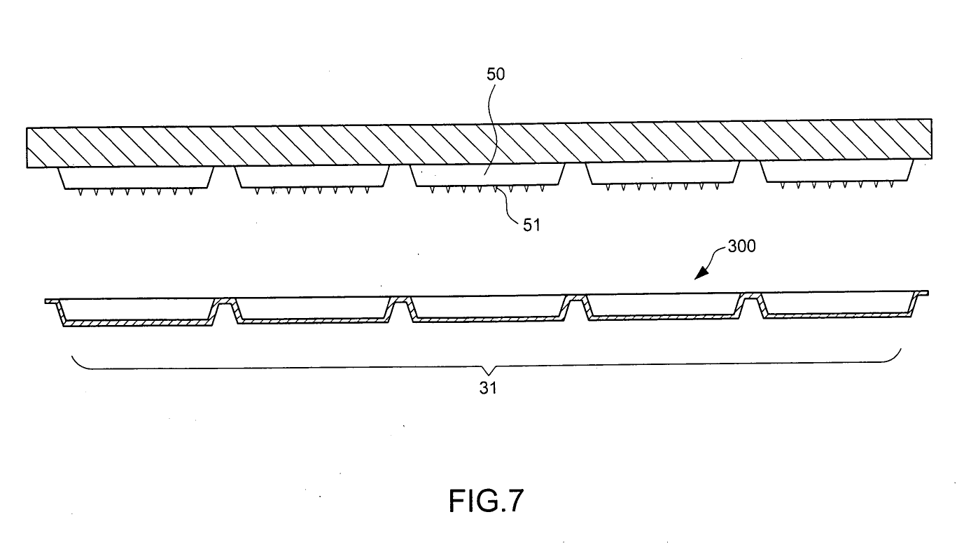

The step of d) perforating, see also FIG. 7, is to directly make through holes 301 in the inner layer (the first close-cell foam sheet material 30a) without touching the intermediate layer (the open-cell foam sheet material 30b) and the outer layer (the second close-cell foam sheet material 30c) after the aforesaid thermoforming process. Alternatively, the step of d) perforating can simultaneously be performed during the thermoforming process by using a perforating mold 50 having bottom pins 51 in the thermoforming press to make through holes 301 in the inner layer (the first close-cell foam sheet material 30a) without touching the intermediate layer (the open-cell foam sheet material 30b) and the outer layer (the second close-cell foam sheet material 30c).

The step of e) cutting is to cut each of the open containers 300 from the compound sheet material 30.

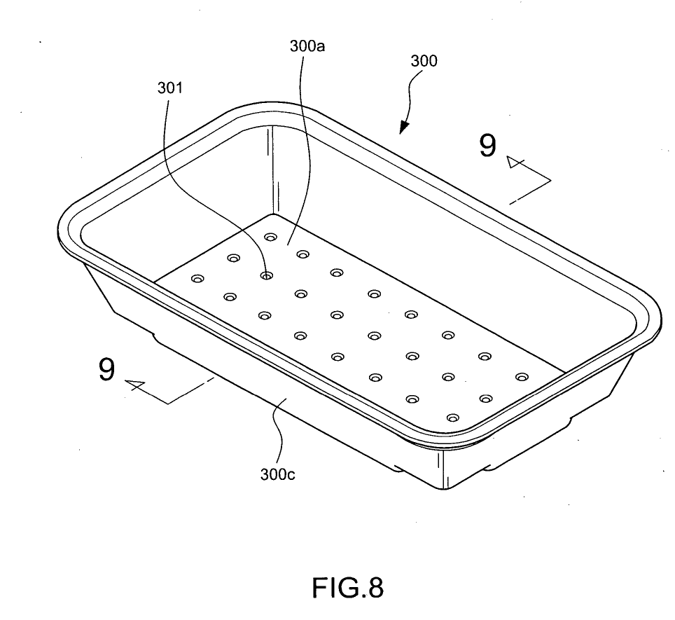

FIG. 8 shows an open container 300 made according to the aforesaid manufacturing method. As illustrated, the inner layer 300a and outer layer 300c are respectively formed of the first close-cell foam sheet material 30a and the second close-cell foam sheet material 30c, and the through holes 301 are formed in the inner layer 300a without reaching the outer layer 300c.

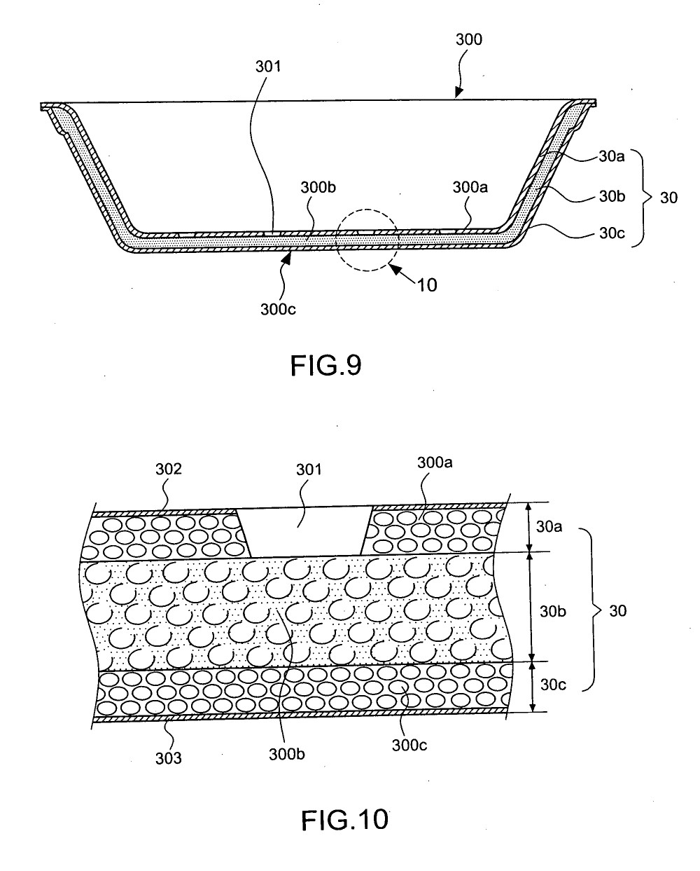

Referring to FIGS. 9 and 10, an open container 300 in accordance with the present invention comprises:

an inner layer 300a formed of a close-cell foam sheet material 30a prepared from polystyrene or polyester and having a plurality of through holes 301 through the top and bottom sides for allowing blood water of storage raw food to pass;

an outer layer 300c formed of a close-cell foam sheet material 30c prepared from polystyrene or polyester; and

an intermediate absorptive layer 300b formed of an open-cell foam sheet material 30b of cell-opening over 80% and bonded between the inner layer 300a and the outer layer 300c for absorbing blood water of storage raw food that passes through the through holes 301.

The aforesaid inner layer 300a, intermediate absorptive layer 300b and outer layer 300c are thermoformed, showing the shape of an open container.

Referring to FIG. 10 again, the top surface 302 of the inner layer 300a and the bottom surface 303 of the outer layer 300c were disposed in contact with the upper and bottom dies of the thermoforming press during thermoforming process. Therefore, the top surface 302 and the bottom surface 303 form a respective shrunk surface, reinforcing the structural strength of the food open container and improving the waterproof characteristic of the inner layer 300a and the outer layer 300c. Therefore, the use of the open container effectively removes blood water from storage raw fish or meat.

Although a particular embodiment of the present invention has been shown and described, it will be understood that various modifications and changes could be made thereunto without departing from the spirit and scope of the invention disclosed.

What is claimed is:

1. An open container comprising:
an inner layer formed of a close-cell foam sheet material, said inner layer having a plurality of through holes through top and bottom sides thereof;
an outer layer formed of a close-cell foam sheet material; and
an intermediate absorptive layer formed of an open-cell foam sheet material and bonded between said inner layer and said outer layer, said open-cell foam sheet material having a cell-opening over 80%.

2. The open container as claimed in claim 1, wherein the close-cell foam sheet materials of said inner layer and said outer layer have a cell-opening below 20%.

3. The open container as claimed in claim 1, wherein the close-cell foam sheet materials of said inner layer and said outer layer and the open-cell foam sheet material of said intermediate layer are respectively molded from polystyrene.

4. The open container as claimed in claim 1, wherein the close-cell foam sheet materials of said inner layer and said outer layer and the open-cell foam sheet material of said intermediate layer are respectively molded from polyester.

5. An open container manufacturing method comprising the steps of:
a) using at least one extruding machine to extrude polymer compounds into a first close-cell foam sheet material having a cell-opening below 20%, a second close-cell foam sheet material having a cell-opening below 20%, and an open-cell foam sheet material having a cell-opening over 80%, each said polymer compounds being a mixture of additives and one of polyester and polystyrene;
b) laminating said first close-cell foam sheet material, said second close-cell foam sheet material and said open-cell foam sheet material into a compound sheet material in which said open-cell foam sheet material is bonded between said first close-cell foam sheet material and said second close-cell foam sheet material;
c) thermoforming said compound sheet material to form a plurality of open containers in said compound sheet material, keeping said first close-cell foam sheet material on the inside of each of said open containers and said second close-cell foam sheet material on the outside of each of said open containers;
d) making through holes through top and bottom sides of said first close-cell foam sheet material; and
e) cutting each of said open containers from said compound sheet material.

6. The open container manufacturing process as claimed in claim 5, wherein said additives include a foaming agent.

7. The open container manufacturing process as claimed in claim 5, a first extruding machines is used to extrude said first close-cell foam sheet material and said second close-cell foam sheet material, and a second extruding machine is used to extrude said open-cell foam sheet material.

8. The open container manufacturing process as claimed in claim 5, wherein a first extruding machines is used to extrude said first close-cell foam sheet material, a second extruding machine is used to extrude said second close-cell foam sheet material, and a third extruding machine is used to extrude said open-cell foam sheet material.

9. The open container manufacturing process as claimed in claim 5, wherein the step d) making through holes through top and bottom sides of said first close-cell foam sheet material is performed together with the step c) thermoforming said compound sheet material to form a plurality of open containers in said compound sheet material by means of the use of a perforating mold having bottom pins.
